(19) United States
(12) Patent Application Publication
(10) Pub. No.: US 2010/0000254 A1
(43) Pub. Date: Jan. 7, 2010

(54) METHOD OF PRODUCING GAS HYDRATE

(76) Inventors: Masataka Hiraide, Tokyo (JP); Kae Serizawa, Tokyo (JP); Kikuo Nakamura, Tokyo (JP); Nakaoka Makoto, Tokyo (JP)

Correspondence Address: JACOBSON HOLMAN PLLC, 400 SEVENTH STREET N.W., SUITE 600, WASHINGTON, DC, 20004, US

(21) Appl. No.: 12/449,456

(22) PCT Filed: Mar. 13, 2007
(86) PCT No.: PCT/JP2007/054962

§ 371 Date: Aug. 7, 2009

(51) Int. Cl. F25J 3/00; C01B 3/32

(52) U.S. Cl. 62/621; 62/623; 48/127.3

(57) ABSTRACT

Provided is a method of producing gas hydrate at a low cost. An acid gas 3 is removed from a natural gas 1, and after dehydration 5 of accompanying water, part of heavy components which do not produce gas hydrate 10 are separated and removed under a relatively high temperature. Moreover, the rest of the heavy components are taken out in a gas hydrate production step 9 together with an excessive portion of light components not contributing to production of the gas hydrate 10, as a fuel gas 11 which is used as a cooling source or a power source for a cooling system in the gas hydrate production step 9.

### TECHNICAL FIELD

The present invention relates to a method of producing gas hydrate from a raw material gas into which a natural gas is refined.

### BACKGROUND ART

In recent years, as means for safely and economically transporting and storing a natural gas, a method using hydrate formed by hydrating components of this natural gas into a solid state (hereinafter referred to as gas hydrate) has been drawing attention. Accordingly, various methods of producing gas hydrate have been proposed (see Patent Document 1, for example).

However, including the above-mentioned Patent Document 1, the methods of producing gas hydrate proposed so far are premised on entirely hydrating a gas (hereinafter referred to as a “raw material gas”) that is supplied to a gas hydrate production step.

For this reason, it is necessary to supply a raw material gas to the gas hydrate production step after the following refinement. Specifically, components which form no gas hydrate or form gas hydrate with extreme difficulty (hereinafter referred to as “heavy components”), and butane are almost completely removed out of the natural gas to thereby obtain the raw material gas mainly containing components, such as methane and ethane, which forms gas hydrate (hereinafter referred to as “light components”).

Here, typical examples of such heavy components include pentane and components having carbon numbers equal or greater than that of pentane, such as hexane.

A process concerning a conventional method of producing gas hydrate is shown in FIG. 5.

In this process, acid gases 73 such as H₂S or CO₂ are removed out of a natural gas 71 in an acid gas removal step 72, then dehydration 75 of water contained at that time is performed in a dehydration step 74, and then substantial part of heavy components 77 is removed in a heavy component separation step to thereby refine the natural gas into 71a raw material gas 78. Then, gas hydrate 81 is produced out of the refined raw material gas 78.

A portion of the refined raw material gas 78 in excess of the amount required for producing the gas hydrate 81 is taken out as a fuel gas 79 before the refined raw material gas 78 is forwarded to a gas hydrate production step 80, and is used as a fuel for a boiler and the like

However, in this production process, it is necessary to almost completely remove the heavy components and butane in steps concerning refinement of the raw material gas 71 such as the heavy component separation step 76. Accordingly, there is a problem of increases in production costs of the gas hydrate 81 and in equipment expenses for plant instruments and the like.

This point will be described below in detail.

FIG. 6 shows a system diagram of a plant for carrying out the steps concerning the refinement of the raw material gas in the above-described gas hydrate production process. Note that constituents which are the same as those shown in FIG. 5 are denoted by the same reference numerals.

This plant mainly includes: an absorption tower 90 for removing the acid gases 73 out of the natural gas 71; a dehydration tower 91 for performing dehydration; and a distillation tower 93 for removing the heavy components 77.

The natural gas 71 is washed with a solution of an amine or the like in the absorption tower 90 to remove the acid gases 73, then dehydrated by allowing an absorbent 92 such as molecular sieve inside the dehydration tower 91 to absorb accompanying water, then subjected to separation of the heavy components 77 in the distillation tower 93, liquefied with a condensing unit 94, and then pressurized to a predetermined pressure with a compressor 96, to be thereby produced into the raw material gas 78.

In order to refine the natural gas 71 into the raw material gas 78 by almost completely separating and removing the heavy components and butane from the natural gas 71 in such a plant, it is necessary to set the temperature to −60° C. to −70° C. at an exit of the condensing unit 94 in the case where an operating pressure of the distillation tower 93 is set to 3.6 MPaG, for example. Accordingly, it is necessary to maintain an external refrigerant flowing through the condensing unit 94 at −70° C. or below.

However, under present circumstances, it is impossible to achieve such a low temperature with only one type of refrigerant, and it is therefore necessary to separately provide a complicated and huge cooling system which includes two types of refrigerants of ethane and propane, for example. Hence, there has been a problem of an increase in production costs of the gas hydrate 81.

In addition, it is also necessary to manufacture the plant instruments such as the distillation tower 93 and the condensing unit 94 by use of an expensive material that can endure the low temperature, such as high nickel stainless steel. Accordingly, there has also been a problem of an increase in equipment expenses.

Patent Document 1: Japanese patent application Kokai publication No. 2004-10686

### DISCLOSURE OF THE INVENTION

### Problems to be Solved by the Invention

The present invention has been made in view of these problems. An object of the present invention is to provide a method of producing gas hydrate which is capable of producing gas hydrate at low costs.

### Means for Solving the Problem

To attain the object, the present invention according to claim 1 provides a method of producing a gas hydrate in which gas hydrate is produced from a raw material gas, characterized by including: refining a natural gas into the raw material gas by separating part of heavy components therefrom, and producing the gas hydrate while the rest of the heavy components are being separated from the raw material gas together with part of light components as a fuel gas.

Here, the heavy components mean components which form no gas hydrate or which form gas hydrate with extreme difficulty.

Meanwhile, the light components mean components which can form gas hydrate.

The invention according to claim 2 provides the method of producing a gas hydrate according claim 1, which is characterized in that the raw material gas is produced through refinement in accordance with a refining method and thereafter pressurization using a compressor up to a second pressure, the refining method including the steps of: separating a first heavy component by at least partially liquefying the natural gas through cooling-down to a predetermined temperature by using a cooler; separating a second heavy component by at least partially liquefying the natural gas through a decrease in pressure to a first pressure by using an expander; and collecting, from the first heavy component and the second heavy component, the light components accompanying therewith by utilizing a difference in vapor pressure in a distillation tower.

The invention according to claim 3 provides the method of producing a gas hydrate according to claim 2, which is characterized in that motive power recovered by the expander is used as part of rotating power for the compressor.

The invention according to claim 4 provides the method of producing a gas hydrate according to any one of claims 1 to 3, using cooling means including: a compressor for pressuring a first refrigerant; a condensing unit for liquefying the pressurized first refrigerant; a cooler for cooling the liquefied first refrigerant by heat exchange with a second refrigerant; a heat exchanger for performing cooling by use of the cooled first refrigerant; and a gas-liquid separator for separating gas components from the first refrigerant heated by the heat exchanger. In the method, the second refrigerant is cooled by an absorption refrigerator which uses steam as a heat source, the steam being generated by a boiler using the fuel gas as a fuel.

The invention according to claim 5 provides the method of producing a gas hydrate according to claim 4, which is characterized in that the steam is used as part of rotating power for the compressor.

### EFFECT OF THE INVENTION

According to the present invention, in the gas hydrate production process, part of the heavy components which do not form the gas hydrate are taken out of the raw material gas together with the light components that produce the gas hydrate. As a result, refinement of the raw material gas can be performed under a relatively high temperature. Therefore, it is possible to reduce costs concerning production of the gas hydrate.

Moreover, by using the light components taken out in the gas hydrate production process as a cooling source and a power source for the cooling means in the gas hydrate production process, it is possible to reduce motive power energy for the compressor concerning the cooling means. Therefore, it is possible to further reduce costs for producing the gas hydrate.

### BRIEF DESCRIPTION OF THE DRAWINGS

FIG. 1 is a block diagram of a process concerning a method of producing gas hydrate according to the present invention.

FIG. 2 is a system diagram of a plant for carrying out a step concerning refinement of a raw material gas in the method of producing gas hydrate according to the present invention.

FIG. 3 is a system diagram of a conventional cooling system in a gas hydrate production process.

FIG. 4 is a system diagram of a cooling system utilizing the present invention in the gas hydrate production process.

FIG. 5 is a block diagram of a process concerning a conventional method of producing gas hydrate.

FIG. 6 is a system diagram of a plant for carrying out a step concerning refinement of a raw material gas in the conventional method of producing gas hydrate.

### EXPLANATION OF REFERENCE NUMERALS

1, 71 NATURAL GAS
2, 72 ACID GAS REMOVAL STEP
3, 73 ACID GAS
4, 74 DEHYDRATION STEP
5, 75 WATER
6, 76 HEAVY COMPONENT SEPARATION STEP
7, 77 HEAVY COMPONENTS
8, 78 RAW MATERIAL GAS
9, 80 GAS HYDRATE PRODUCTION STEP
10, 81 GAS HYDRATE
11 FUEL GAS (CONTAINING HEAVY COMPONENTS SEPARATED IN GAS HYDRATE PRODUCTION STEP)
20, 90 ABSORPTION TOWER
21, 91 DEHYDRATION TOWER
22, 92 ABSORBENT
23 FIRST COOLER
24 FIRST GAS-LIQUID SEPARATOR
25 SECOND COOLER
26 SECOND GAS-LIQUID SEPARATOR
27 THIRD COOLER
28 THIRD GAS-LIQUID SEPARATOR
29 GAS EXPANDER
30 FOURTH GAS-LIQUID SEPARATOR
31 PIPING FOR LIQUID PHASE
32 HEATER
33, 93 DISTILLATION TOWER
34 PIPING FOR LIGHT COMPONENTS
35, 51, 96 COMPRESSOR
36, 50, 95 ELECTRIC MOTOR
37 ROTATING POWER
38 CONDENSER
52, 94 CONDENSING UNIT
53 VALVE
54 HEAT EXCHANGER
55 PLANT COOLING SYSTEM
56 REFRIGERANT
57 GAS-LIQUID SEPARATOR
58 PROPANE GAS
60 COOLER
61 BOILER
62a STEAM FOR REFRIGERATOR
62b STEAM FOR POWER SOURCE
63 ABSORPTION REFRIGERATOR
64 COLD WATER
79 FUEL GAS
A RAW MATERIAL GAS REFINEMENT STEPS
B SEAWATER
X UNREACTED CASE
Y REACTED CASE

### BEST MODE FOR CARRYING OUT THE INVENTION

An embodiment of the present invention will be described with reference to the drawings. Note that equipment and the like common to the drawings below will be denoted by the same reference numerals.

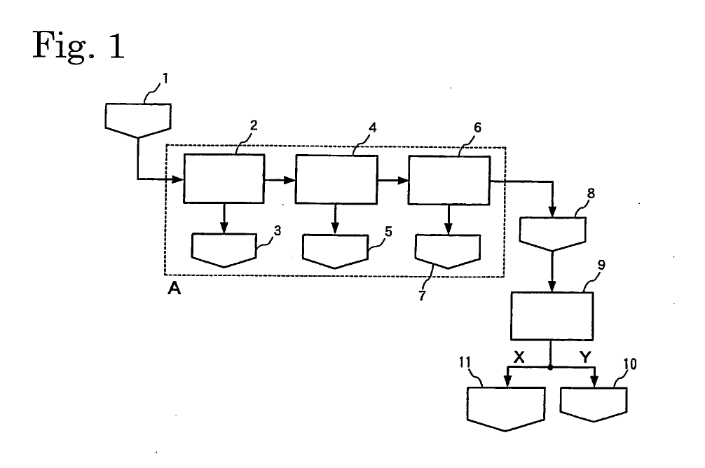

A process concerning a method of producing gas hydrate according to the present invention is shown in FIG. 1.

This method of producing gas hydrate is characterized in that removal of heavy components 7 is carried out not only in a step concerning refinement of a raw material gas 8 but also in gas hydrate production step 9.

Specifically, by allowing the heavy components together with light components to be removed as a fuel gas 11 in the gas hydrate production step 9, a raw material gas 8 to be supplied to the gas hydrate production step 9 can be accompanied with a higher proportion of the heavy components than a conventional case. As a result, it is possible to modify operating conditions in steps concerning refinement of the raw material gas 8 such as a heavy component separation step 6.

However, the concentration of the heavy components accompanying with the raw material gas 8 needs to be controlled to a concentration so as not to cause condensation of the raw material gas 8 in the gas hydrate production step 9.

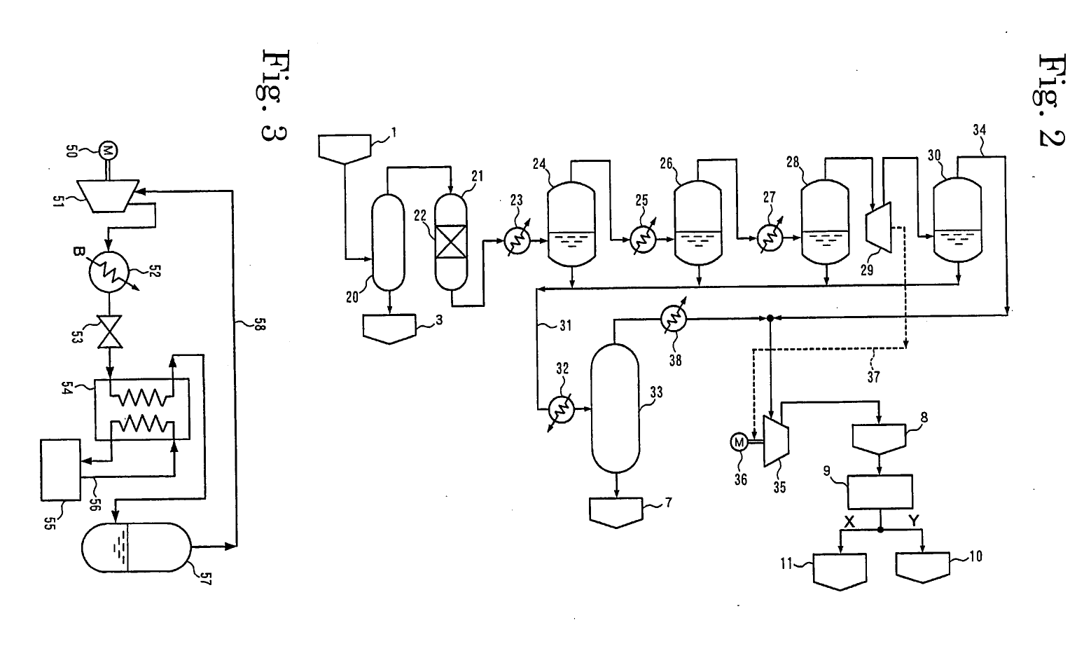

A system diagram of a plant for carrying out a step concerning refinement of the raw material gas in the above-described gas hydrate production step is shown in FIG. 2.

This plant mainly includes an absorption tower 20 for removing acid gases 3 from a natural gas 1, a dehydration tower 21 for dehydrating the gas after removing the acid gases 3, three coolers (23, 25, and 27) and four gas-liquid separators (24, 26, 28, and 30) for separating the heavy components 7 from the dehydrated gas, and a distillation tower 33 to which liquid phase portions of the gas-liquid separators are connected.

Next, a method of refining the raw material gas of the gas hydrate using this plant system will be described below.

Here, a case of setting the pressure of the natural gas 1 to be processed by this plant equal to 9.4 MPaG and setting the temperature thereof equal to 30° C. is taken as an example.

First, the acid gases 3 are removed from the natural gas 1 in the absorption tower 20 and the accompanying water is dehydrated in the dehydration tower 21 by means of absorption with an absorbent 22 such as molecular sieve 22.

Thereafter, the supplied gas is cooled in three stages by use of a first cooler 23, a second cooler 25, and a third cooler 27, thereby liquefying and separating the heavy components by use of a first gas-liquid separator 24, a second gas-liquid separator 26, and a third gas-liquid separator 28 sequentially from ones with lower boiling points.

Moreover, a gas component from the third gas-liquid separator 28 is expanded to 3.6 MPaG with a gas expander 29 so as to further cool down with coldness generated in that expansion, thereby liquefying and separating the heavy components by use of a fourth gas-liquid separator 30.

Operating temperatures in the series of this heavy component separation step are 0° C. for the first cooler 23, −8° C. for the second cooler 25, −20° C. for the third cooler 27, and −46° C. inside the fourth gas-liquid separator 30, for example.

Meanwhile, pentane, butane, propane, and the like are cited as the components to be liquefied.

Therefore, the gas component in the fourth gas-liquid separator 30 becomes a gas that contains methane as a main component and a small amount of heavy components, and is supplied as part of the raw material gas 8 in the gas hydrate production step 9.

As described above, while it is necessary to cool the raw material gas down to −60° C. to −70° C. by using an external refrigerant in the conventional step concerning refinement of the raw material gas, it is only necessary to cool the raw material gas down to approximately −20° C. in the present invention. Hence it is apparent that the plant can be operated at a higher temperature than the conventional case.

Note that it is possible to use propane, propylene, or a mixture of propane and ethane as the external refrigerant.

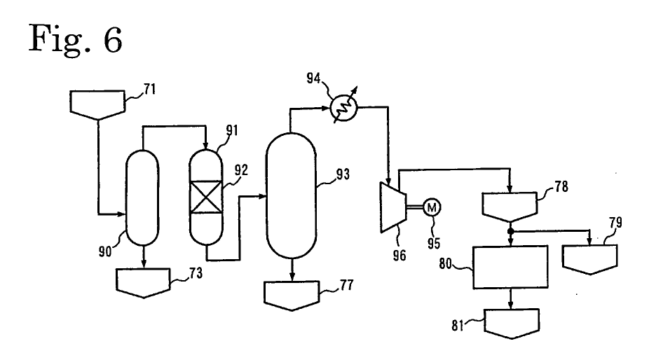

This means that heat quantity required for refining the same amount of the raw material gas 8 becomes nearly half as much as heat quantity in the conventional refining step shown in FIG. 6.

For this reason, it is possible to simplify the cooling system concerning separation of the heavy components and to manufacture the plant instruments such as the coolers and the gas-liquid separators by use of an inexpensive material such as carbon steel. Accordingly, it is possible to reduce manufacturing costs concerning the gas hydrate 10 as well as equipment expenses.

Here, since the light components such as methane are included in the liquids separated by the respective gas-liquid separators (24, 26, 28, and 30), the liquids are sent to the distillation tower 33 through piping 31 for liquid phase and a heater 32 so as to separate and collect the light components by utilizing a difference in vapor pressure among the gas components.

In this way, it is possible to further enhance separation efficiency of the light components from the natural gas 1.

Note that the heavy components 7 separated in the distillation tower 33 can be used as natural gasoline (NGL).

The light components separated by the distillation tower 33 are sent to a compressor 35 together with gas components taken out of a top portion of the fourth gas-liquid separator 30 through a compressor 38. Then, the pressure of these components is then raised to 5.6 MPaG which is a condition for producing the gas hydrate 10. Thus, the natural gas 1 is refined into the raw material gas 8.

While the compressor 35 is driven by an electric motor 36, it is possible to further reduce the costs concerning production of the gas hydrate 10 by reducing motive power energy for the electric motor 36 by means of transmitting motive power 37 generated as rotating power of a turbine by the above-mentioned gas expander 29.

Meanwhile, in the gas hydrate production step 9, the heavy components not contributing to the production of the gas hydrate 10 are taken out together with the light components of the raw material gas 8 as the fuel gas 11. Here, it is possible to achieve further reduction in the costs concerning production of the gas hydrate 10 by effectively using this fuel gas 11 as a cooling source and a power source for the cooling means in the gas hydrate production step 9.

A system diagram of a conventional cooling system in a gas hydrate production process is shown in FIG. 3.

This cooling system employs propane as a refrigerant. The propane that is pressurized with a compressor 51 is liquefied in a condensing unit 52 through heat exchange with seawater. Then, after the temperature is lowered by way of Joule-Thomson expansion utilizing a valve 53, a refrigerant 56 in a cooling system 55 of a gas hydrate production plant is cooled in a heat exchanger 54.

The propane that is heated by way of heat exchange with the refrigerant 56 in the heat exchanger 54 is subjected to collection of gas components 58 in a gas-liquid separator 57. The collected gas component 58 is sent back to the compressor 51 and pressurized again.

The motive power for the compressor 51 is the largest factor in the operating costs of such a cooling system. While the motive power for this compressor 51 changes significantly depending on the intake amount of the gas component 58 and the degree of pressure increase of the gas component, it is necessary to reduce the intake amount of the gas component 58 in order to reduce the motive power for the compressor because the degree of pressure increase is determined by the liquefying pressure in the condensing unit 52 at the temperature of the seawater.

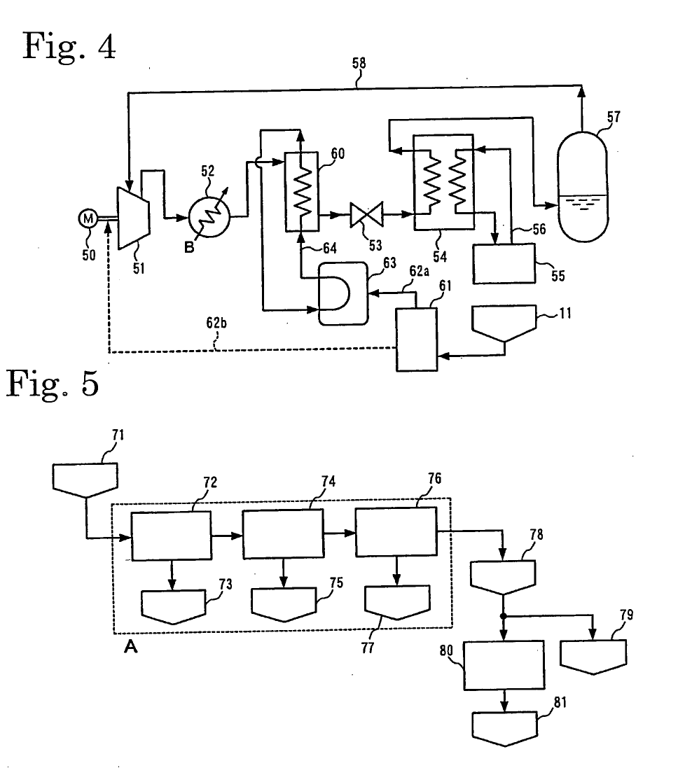

A system diagram of a cooling system using the method of producing gas hydrate according to the present invention is shown in FIG. 4.

In this cooling system, a cooler 60 is disposed at a later stage of the condensing unit 52 to supercool propane, which leads to reduction in flash rate. Thus, the amount of the gas components 58 to be taken in by the compressor 51 is reduced.

Cold water 64 used as a refrigerant in the cooler 60 is cooled down by an absorption refrigerator 63 that utilizes steam 62a generated from a boiler 61, which uses the fuel gas 11 taken out in the gas hydrate production step as the fuel.

Here, it is possible to achieve further reduction in the motive power for the compressor by using part 62b of the steam generated from the boiler 61 as part of rotating power for the compressor 51.

For example, when approximately 1.8% of the raw material gas refined in the plant shown in FIG. 2 is used as the fuel gas 11 in this cooling system, it is possible to reduce the motive power for an electric motor 50 of the compressor 51 by approximately 18%.

1-5. (canceled)

6. A method of producing gas hydrate in which gas hydrate is produced from a raw material gas, characterized by comprising:
refining a natural gas into the raw material gas by separating part of heavy components therefrom; and
producing the gas hydrate while the rest of the heavy components are being separated from the raw material gas together with part of light components as a fuel gas.

7. The method of producing gas hydrate according to claim 6, wherein the raw material gas is produced through refinement in accordance with a refining method and thereafter pressurization using a compressor up to a second pressure,
the refining method including the steps of:
separating a first heavy component by at least partially liquefying the natural gas through cooling-down to a predetermined temperature by using a cooler;
separating a second heavy component by at least partially liquefying the natural gas through a decrease in pressure to a first pressure by using an expander; and
collecting, from the first heavy component and the second heavy component, the light components accompanying therewith by utilizing a difference in vapor pressure in a distillation tower.

8. The method of producing gas hydrate according to claim 7, wherein motive power recovered by the expander is used as part of rotating power for the compressor.

9. The method of producing gas hydrate according to claim 6, using cooling means comprising: a compressor for pressuring a first refrigerant; a condensing unit for liquefying the pressurized first refrigerant; a cooler for cooling the liquefied first refrigerant by heat exchange with a second refrigerant; a heat exchanger for performing cooling by use of the cooled first refrigerant; and a gas-liquid separator for separating gas components from the first refrigerant heated by the heat exchanger, wherein
the second refrigerant is cooled by an absorption refrigerator which uses steam as a heat source, the steam being generated by a boiler using the fuel gas as a fuel.

10. The method of producing gas hydrate according to claim 7, using cooling means comprising: a compressor for pressuring a first refrigerant; a condensing unit for liquefying the pressurized first refrigerant; a cooler for cooling the liquefied first refrigerant by heat exchange with a second refrigerant; a heat exchanger for performing cooling by use of the cooled first refrigerant; and a gas-liquid separator for separating gas components from the first refrigerant heated by the heat exchanger, wherein
the second refrigerant is cooled by an absorption refrigerator which uses steam as a heat source, the steam being generated by a boiler using the fuel gas as a fuel.

11. The method of producing gas hydrate according to claim 8, using cooling means comprising: a compressor for pressuring a first refrigerant; a condensing unit for liquefying the pressurized first refrigerant; a cooler for cooling the liquefied first refrigerant by heat exchange with a second refrigerant; a heat exchanger for performing cooling by use of the cooled first refrigerant; and a gas-liquid separator for separating gas components from the first refrigerant heated by the heat exchanger, wherein
the second refrigerant is cooled by an absorption refrigerator which uses steam as a heat source, the steam being generated by a boiler using the fuel gas as a fuel.

12. The method of producing gas hydrate according to claim 9, wherein the steam is used as part of rotating power for the compressor.

13. The method of producing gas hydrate according to claim 10, wherein the steam is used as part of rotating power for the compressor.

14. The method of producing gas hydrate according to claim 11, wherein the steam is used as part of rotating power for the compressor.
